(19) United States
(12) Patent Application Publication
(10) Pub. No.: US 2002/0168622 A1
(43) Pub. Date: Nov. 14, 2002

(54) Method of demonstrating the performance of a cleaning pad and artificial soil composition therefor

(75) Inventors: Douglas Addison Cates, Cincinnati, OH (US); Kelly Sue Penhorwood, Cincinnati, OH (US); Robert Allen Godfroid, West Chester, OH (US); Michael Martyn Headlam, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/087,317

(22) Filed: Mar. 1, 2002

Related U.S. Application Data
(60) Provisional application No. 60/272,910, filed on Mar. 2, 2001.

(51) Int. Cl. G09B 25/00

(52) U.S. Cl. 434/365; 106/638

(57) ABSTRACT

A method of demonstrating the cleaning performance of a cleaning pad comprises the steps of: (a) providing a soil composition comprising fine particulate matter, optional colorant, and optional dispersant; wherein said soil composition has a mean particle size of from about 1 μm to about 1,000 μm; (b) distributing said soil composition on a demonstration surface; and (c) wiping said demonstration surface with said cleaning pad. A soil composition for use in said methods comprises: (a) fine particulate matter; (b) optional colorant; and (c) optional dispersant; wherein said soil composition has a mean particle size of from about 1 μm to about 1,000 μm. The soil composition is preferably dispersed in an aqueous carrier to form a soil dispersion.

### CROSS REFERENCE TO RELATED APPLICATIONS

This application claims priority under 35 U.S.C. §119(e) to U.S. Provisional Application Serial No. 60/272,910, filed Mar. 2, 2001 (Attorney Docket No. 8442P).

### TECHNICAL FIELD

The present invention relates to methods of demonstrating the cleaning performance of a cleaning pad and to soil compositions that can be used in said methods.

### BACKGROUND OF THE INVENTION

Consumer products, especially ones that represent new cleaning concepts to a consumer, can benefit greatly by having reliable methods to demonstrate the cleaning performance of the consumer product. Demonstration methods that effectively present the benefits of a consumer product to the consumer typically result in a greater chance that a consumer will try the product.

Some test methods have utilized soil material that has been collected from soiled household surfaces, which has gradually accumulated naturally over time on the household surfaces. For example, test methods have utilized soil material recovered from vacuum cleaner bags/containers. While this soil is representative of the types of soil material found on soiled household surfaces, it tends to be highly variable in composition and thus can result in less effective test methods. Also, the mean particle size of such soil materials tend to be relatively high, which can also result in less effective test methods, especially those relating to cleaning pads. Such soil materials are therefore also undesirable to use in methods for demonstrating the cleaning performance of a cleaning pad, especially to consumers.

The marketing and sales promotion of cleaning pads, such as those to be used with mops for cleaning floors, can benefit from conducting demonstrations that are presented to consumers, either live or via broadcast media, to show the cleaning performance of the cleaning pad. It has thus been desired to create methods for demonstrating the cleaning performance of a cleaning pad that are easily repeatable and that provide consistent results. It has further been desired to create a soil composition/dispersion that can be used in such demonstration methods to achieve the aforementioned benefits.

### SUMMARY OF THE INVENTION

The present invention relates to a method of demonstrating the cleaning performance of a cleaning pad, said method comprising the steps of: (a) providing a soil composition comprising fine particulate matter, optional colorant, and optional dispersant; wherein said soil composition has a mean particle size of from about 1 μm to about 1,000 μm; (b) distributing said soil composition on a demonstration surface; and (c) wiping said demonstration surface with said cleaning pad. The present invention further relates to a soil composition for use in said methods, said composition comprising: (a) fine particulate matter; (b) optional colorant; and (c) optional dispersant; wherein said soil composition has a mean particle size of from about 1 μm to about 1,000 μm. The soil composition is preferably dispersed in an aqueous carrier to form a soil dispersion.

The soil compositions/dispersions of the present invention include a number of beneficial aspects, such as providing a soil composition: that is shelf stable and easily transported; that has an excellent human safety profile; that has an appearance very similar to common household soils; that is made of predominately commonly available, inexpensive materials; that is easily dispersed; and that is designed to be picked up readily into a cleaning pad, causing a dark color upon absorption.

The methods of the present invention also include a number of beneficial aspects, such as: the demonstration can be performed on a quick cycle time (<1 minute, if necessary) with little to no preparation or drying time necessary; and the demonstration can be performed repeatedly with little to no build-up of soil on the demonstration surface.

### DETAILED DESCRIPTION OF THE INVENTION

The present invention relates to methods of demonstrating the cleaning performance of a cleaning pad and artificial soil compositions/dispersions therefor.

I. Methods of Demonstrating the Performance of a Cleaning Pad

The methods of the present invention are useful in demonstrating the cleaning performance of a cleaning pad. The present methods are important to show consumers the effectiveness of a cleaning pad for removing, absorbing, and retaining soil from a surface, especially a household surface such as linoleum tile. An important aspect of the present methods is the ability to demonstrate the cleaning performance of a cleaning pad on a consistent basis such as when practicing the method repeatedly over relatively short time periods. Such demonstrations can be conducted in retail stores, in television commercials, in video streaming via the Internet, as well as other broadcast media and other live venues. The demonstration methods herein are relatively easy to perform and do not require a long period of time to set-up and complete the demonstration method. The soil compositions/dispersions of the present invention are an important aspect of the present methods in order to achieve these benefits from the methods.

The methods of demonstrating the cleaning performance of a cleaning pad generally comprise the steps of:

(a) providing a soil composition/dispersion comprising fine particulate matter, optional colorant, and optional dispersant;

(b) distributing said soil composition/dispersion on a demonstration surface; and

(c) wiping said demonstration surface with said cleaning pad.

Demonstration surfaces suitable for use in the present methods include, but are not limited to, linoleum, ceramic tile, vinyl, wood, coated concrete, and the like. The demonstration surface is typically covers a relatively small area, for example, an area of about 3 feet by 3 feet.

The soil composition/dispersion is typically distributed across the demonstration surface at a level of less than about 6 ml per square foot, preferably from about 0.5 ml per square foot to about 4 ml per square foot, and more preferably from about 1 ml per square foot to about 2 ml per square foot. If appropriate, the soil composition/dispersion can be distributed onto the demonstration surface using a large pipette to extract an aliquot of suspended soil (if using a soil dispersion) and then distribute to the surface by releasing the soil composition/dispersion from the pipette.

In order to enhance the coverage of the demonstration surface with the soil composition/dispersion, a spatula or similar utensil can be used to spread the soil composition/dispersion across the surface to more evenly cover the demonstration surface with the soil composition/dispersion.

The soil composition can be provided in dry form, which can then be subsequently combined with an aqueous carrier to form a soil dispersion. The soil dispersion can then be used in the present methods. In a preferred embodiment, the soil composition is in dry form and contained in a plastic jar having a line marked thereon. The plastic jar can then be filled with water to form a soil dispersion until the level of the soil dispersion reaches the line marked on the plastic jar. Once the soil dispersion is formed, the plastic jar can be gently agitated to ensure complete dispersion of the soil composition in the aqueous carrier. This allows for easy and quick preparation of a soil dispersion for use in the present methods and allows the soil composition to be conveniently and neatly transported to the demonstration method location.

Once the soil composition/dispersion has been distributed across the demonstration surface, the cleaning pad can be wiped across the surface to absorb/remove the soil composition/dispersion from the surface. The demonstration surface and the cleaning pad can then be shown to the consumer to whom the demonstration is directed to show the cleanliness of the demonstration surface and the soil that has been absorbed/removed into the cleaning pad. The present soil compositions/dispersions preferably comprise a colorant to enhance the ability of the consumer to observe the soil that has been absorbed/removed from the surface into the cleaning pad.

After the soil composition/dispersion is distributed across the demonstration surface, a hard surface cleaning solution can be applied to the demonstration surface before wiping the cleaning pad across the surface to enhance the absorption/removal of the soil composition/dispersion from the surface. Any known hard surface cleaning solutions can be used and preferred cleaning solutions are described in detail in copending U.S. application Ser. Nos.: 09/381,550 filed Mar. 16, 1998; 09/509,603 filed Apr. 6, 2000; 09/700,556 filed May 18, 1999; 09/655,221 filed Sep. 5, 2000; and 09/671,080 filed Sep. 27, 2000; and International Application Nos.: PCT/US99/27893 (published as WO 00/32727); PCT/US99/26579 (published as WO 00/27271); PCT/US00/10385 (published as WO 00/63333); all of which are incorporated herein by reference.

The cleaning pad can preferably be attached to a cleaning implement and then wiped across the demonstration surface. Preferred cleaning implements comprise a fluid dispenser that can dispense a hard surface cleaning solution as described hereinbefore. Such preferred cleaning implements are described in detail in U.S. Pat. Nos. 6,142,750; 5,988,920; 5,888,006; D401,703; and D428,226; all of which are incorporated herein by reference.

The present invention further encompasses a demonstration kit for demonstrating the cleaning performance of a cleaning pad, said kit comprising: (a) a soil composition/dispersion, as described herein (preferably contained in a plastic jar); (b) at least one cleaning pad to be demonstrated, as described herein; (c) optionally, a demonstration surface, as described herein; (d) optionally, a measuring device, preferably a large pipette; (e) optionally, a spatula or similar implement; (f) optionally, a hard surface cleaning solution, as described herein; and (g) optionally, a cleaning implement, preferably comprising a fluid dispenser. The kit preferably further comprises a set of instructions comprising instructions to demonstrate the cleaning performance of the cleaning pad by carrying out the steps of the methods described herein.

II. Artificial Soil Compositions/Dispersions

The soil compositions used in demonstrating the cleaning performance of a cleaning pad generally comprise fine soil particulate matter, optional colorant, and an optional dispersant. The present soil compositions are preferably dispersed in an aqueous carrier comprising water to form soil dispersions. The soil dispersions are then preferably used in the methods of the present invention to demonstrate the cleaning performance of a cleaning pad.

The mean particle size of the soil composition/dispersion is especially important for using in the demonstration methods of the present invention. If the mean particle size to too large, the soil composition/dispersion is difficult to uniformly spread across the demonstration surface, resulting in a less effective demonstration method. The soil compositions/dispersions of the present invention generally have a mean particle size of from about 1 μm to about 1,000 μm, preferably from about 10 μm to about 600 μm, and more preferably from about 10 μm to about 200 μm. The mean particle size of the soil composition/dispersion is measured using a Horiba® LA-900 particle size analyzer.

In a preferred embodiment, the soil composition/dispersion of the present invention is comprised of at least 60% of particles having a particle size of less than about 200 μm, preferably less than about 100 μm.

Another preferred characteristic relates to the average soil suspension of the soil compositions/dispersions. In order to achieve uniform distribution of the soil composition/dispersion across the demonstration surface, the components of the soil composition/dispersion need to remain adequately dispersed over time. The average soil suspension of the soil compositions/dispersions is measured according to the Average Soil Suspension Test Method described in Section IV hereinafter. As measured via such method, the present soil compositions/dispersions will typically exhibit a sedimentation line (described hereinafter in Section IV), after 5 minutes, at greater than about 150 ml, preferably greater than about 200 ml, and more preferably greater than about 225 ml, as measured according to the Average Soil Suspension Test Method.

The soil compositions/dispersions of the present invention are preferably free of soil material collected directly from soiled household surfaces (i.e. naturally-occurring household soil material). Such soil material can include soil recovered from vacuum cleaner bags/containers, soil material recovered from dusting cloths, soil material swept-up and collected from household floors, and other similar soil material that has gradually formed naturally on household surfaces over time.

A. Fine Particulate Matter

Fine particulate matter that is suitable in the present soil compositions include a variety of materials, such as clay, cement, silica sand, limestone, perlite, volcanic aggregate, alumina trihydrate, ground quartz, volcanic ash, fine sand, talc, mica, calcium carbonate marble dust, humic soil, loam, loess, other fine inert materials, or mixtures thereof. The fine particulate matter is selected to provide the appropriate mean particle size for the soil composition, as described hereinbefore. Preferred fine particulate matter for incorporation in the present soil compositions includes clay, cement, and mixtures thereof.

The present soil compositions generally comprise from about 1% to about 99%, preferably from about 20% to about 99%, and more preferably from about 50% to about 99%, by weight of the soil composition, of fine particulate matter.

In a preferred embodiment, the fine particulate matter of the soil composition comprises clay and cement. This preferred soil composition comprises from about 1% to about 99%, preferably from about 50% to about 90%, and more preferably from about 60% to about 75%, by weight of the soil composition, of clay; and from about 1% to about 99%, preferably from about 5% to about 50%, and more preferably from about 20% to about 40%, by weight of the soil composition, of cement. A preferred clay for use in the soil composition is commercially available from Kentucky-Tennessee Clay Company (Mayfield, Ky. USA) under the trade name Todd Dark Clay. A preferred cement for use in the soil composition is commercially available from Quickcrete® under the trade name Type I Portland Cement.

B. Optional Colorant

Colorants are optionally, but preferably, incorporated in the present soil compositions to provide an enhanced color to the soil. Colorants can be important to better display the soil composition on the demonstration surface and to better display the absorbed soil in the cleaning pad being demonstrated. The colorants that are incorporated into soil compositions of the present invention are preferably dry or powder colorants such as graphitic carbons (e.g. activated carbon, carbon black, carbon lampblack, activated charcoal, coke, and the like), iron oxide, natural burnt umber, chromium oxide, ultra marine blue, titanium dioxide, and the like, and are commercially available from Harcross Pigments, Inc., Bayer Corporation, Reckitts Colour Ltd., Mallinckrodt Baker Inc., and DuPont Corp. Liquid colorants can also be used in the present invention. If a liquid colorant is used it should be capable of being dispersed in aqueous carrier. Other colorants are described in U.S. Pat. No. 5,362,322 and are incorporated herein by reference.

A preferred colorant is a graphitic carbon, such as activated carbon. A suitable activated carbon colorant is commercially available from Mallinckrodt Baker, Inc. (Phillipsburg, N.J. USA).

In preferred embodiments, the present soil compositions comprise a colorant at a level of from about 0.01% to about 99%, preferably from about 0.01% to about 10%, and more preferably from about 0.1% to about 1%, by weight of the soil composition.

C. Optional Dispersant

The soil compositions of the present invention preferably comprise an optional dispersant. The dispersant is preferred wherein the soil composition is dispersed in an aqueous carrier to form a soil dispersion. The optional dispersant herein is typically selected from the group consisting of surfactants, ethoxylated and/or propoxylated polyalkylamines, carboxylate polymers, nitrogen-based zwitterionic polymers, polyethyleneoxides, polyphosphates, cellulosic polymers, and mixtures thereof. The dispersant is preferably a polyalkyleneimine, such as polyethyleneimine.

Preferred surfactants suitable as dispersants herein include anionic surfactants and nonionic surfactants, such as ethylene oxide condensates, or sulfonated soaps may be used as the dispersant. The most preferred dispersants are anionic or nonionic surfactants. The preferred nonionic surfactants are TRITON X-100, TERGITOL NP9, TRITON N-101 and TRITON CF-10 all commercially available from Union Carbide Co., and MAKON 10 commercially available from Stepan Chemical Co. The preferred anionic surfactants are TRITON X-200 commercially available from Union Carbide Co.; BIOSOFT D-60 commercially available from Stepan Chemical Co.; and DOWFAX 2A1, DOWFAX 3B2, DOWFAX XDS 8292.00 and DOWFAX XDS 8390.00 which are disulfonates commercially available from Dow Chemical Company.

Preferred dispersants herein are selected from a group consisting of ethoxylated and/or propoxylated polyalkylamines, carboxylate polymers, nitrogen-based zwitterionic polymers, polyethyleneoxides, polyphosphates, and cellulosic polymers.

The more preferred dispersants are ethoxylated polyalkylamines. Such dispersants are disclosed in U.S. Pat. No. 4,891,160, issued Jan. 2, 1990, by Vander Meer, which is incorporated herein by reference.

Preferred ethoxylated polyamines can be derived from polyamino amides and/or polyaminopropyleneoxide materials. Preferred ethoxylated amine polymers are the ethoxylated C₂-C₃ polyalkyleneamines and polyalkyleneimines. Particularly preferred ethoxylated polyalkyleneamines and polyalkyleneimines are the ethoxylated polyethyleneamines (PEAS) and polyethyleneimines (PEIs). Each hydrogen atom attached to each nitrogen atom represents an active site for subsequent ethoxylation. Preferred have a molecular weight of from about 140 to about 310, preferably from about 140 to about 200. These PEAs can be obtained by reactions involving ammonia and ethylene dichloride, followed by fractional distillation. The common PEAs obtained are triethylenetetramine (TETA) and tetraethylenepentamine (TEPA). There can also be present cyclic amines with side chains in which nitrogen atoms appear. See U.S. Pat. No. 2,792,372 to Dickson, issued May 14, 1957, which describes the preparation of PEAs and which is incorporated herein by reference. The minimum degree of ethoxylation required for preferred soil suspension performance can vary depending upon the number of units in the PEA.

The PEIs used in preparing the dispersants of the present invention have a molecular weight of at least about 440 prior to ethoxylation, which represents at least about 10 units. Preferred PEIs used in preparing these compounds have an average molecular weight of from about 600 to about 2600. Although linear polymer backbones are possible, branched chains can also occur. The relative proportions of primary, secondary and tertiary amine groups present in the polymer can vary, depending on the manner of preparation. Each hydrogen atom attached to each nitrogen atom of the PEI represents an active site for subsequent ethoxylation. These PEIs can be prepared, for example, by polymerizing ethyleneimine in the presence of a catalyst such as carbon dioxide, sodium bisulfite, sulfuric acid, hydrogen peroxide, hydrochloric acid, acetic acid, etc. Specific methods for preparing PEIs are disclosed in U.S. Pat. No. 2,182,306 to Ulrich et al., issued Dec. 5, 1939; U.S. Pat. No. 3,033,746 to Mayle et al., issued May 8, 1962; U.S. Pat. No. 2,208,095 to Esselmann et al., issued Jul. 16, 1940; U.S. Pat. No. 2,806,839 to Crowther, issued Sep. 17, 1957; and U.S. Pat. No. 2,553,696 to Wilson, issued May 21, 1951 (all incorporated herein by reference).

The preferred dispersants herein are described in more detail in International Application No. PCT/US99/27893 (published as WO 00/32727) having an international filing date of Nov. 24, 1999 by K. W. Willman et al., especially at pages 5 to 11, which is incorporated herein by reference.

In preferred embodiments, the present soil compositions comprise a dispersant at a level of from about 0.1% to about 10%, preferably from about 2% to about 8%, and more preferably from about 4% to about 6%, by weight of the soil composition.

D. Aqueous Carrier

The soil compositions of the present invention are preferably dispersed in an aqueous carrier comprising water to form a soil dispersion. The soil dispersions of the present invention typically comprise from at least about 20%, and from about 40% to about 99.99%, preferably from about 50% to about 99.9%, and more preferably from about 80% to about 99%, by weight of the soil dispersion, of aqueous carrier. The aqueous carrier can further comprise other solvents such as low molecular weight alcohols (e.g. C₆ or lower) and/or acetone, so long as the solvent does not substantially dissolve the fine particulate matter of the soil dispersion.

III. Cleaning Pad

The cleaning pad utilized in the present methods can include a wide variety of cleaning pads. For example, cleaning pads suitable for use in the present methods include sponge mop cleaning pads, synthetic cleaning pads, cellulosic cleaning pads, strip mop pads, nonwoven mop pads, premoistened cleaning pads, multi-layer cleaning pads, and the like.

The cleaning pad typically comprises an absorbent layer and preferably further comprises a liquid pervious scrubbing layer. Preferred cleaning pads for use in the present methods are described in detail in U.S. Pat. Nos. 6,101,661; 6,048,123; 6,045,622; 6,003,191; and 5,960,508; and in copending International Application No. PCT/US99/26579 (published as WO 00/27271) having an international filing date of Nov. 9, 1999; all of which are incorporated herein by reference.

Other suitable cleaning pads for use in the present methods are described in detail in International Application No. PCT/US00/26401 having an international filing date of Sep. 26, 2000, which is incorporated herein by reference.

The cleaning pad will preferably have a t₁₂₀₀ absorbent capacity of at least about 5, preferably at least about 15, and more preferably at least about 25, grams of fluid per gram of cleaning pad. The t₁₂₀₀ absorbent capacity represents the ability of a cleaning pad to absorb fluid under pressure and is measured by the Performance Under Pressure test method, which is described in detail in U.S. Pat. No. 6,048,123 at col. 17, line 39 to col. 19, line 61, which is incorporated herein by reference.

A. Absorbent Layer

The absorbent layer serves to retain any fluid and soil absorbed by the cleaning pad during use. While the scrubbing layer has some affect on the pad's ability to absorb fluid, the absorbent layer plays the major role in achieving desired overall absorbency. Furthermore, the absorbent layer preferably comprises multiple layers which are designed to provide the cleaning pad with multiple planar surfaces and/or density gradients.

From a fluid absorbency perspective, the absorbent layer will be capable of removing fluid and soil from the scrubbing layer so that the scrubbing layer will have capacity to continually remove soil from the surface. The absorbent layer also should be capable of retaining absorbed material under typical in-use pressures to avoid “squeeze-out” of absorbed soil, cleaning solution, etc.

The absorbent layer will comprise any material(s) capable of absorbing and retaining fluid during use. To achieve desired total fluid capacities, it will be preferred to include in the absorbent layer a material having a relatively high capacity (in terms of grams of fluid per gram of absorbent material). As used herein, the term “superabsorbent material” means any absorbent material having a g/g capacity for water of at least about 15 g/g, when measured under a confining pressure of 0.3 psi. Because a majority of the cleaning fluids useful with the present invention are aqueous based, it is preferred that the superabsorbent materials have a relatively high g/g capacity for water or water-based fluids.

Representative superabsorbent materials include water insoluble, water-swellable superabsorbent gelling polymers (referred to herein as “superabsorbent gelling polymers”) which are well known in the literature. These materials demonstrate very high absorbent capacities for water. The superabsorbent gelling polymers useful in the present invention can have a size, shape and/or morphology varying over a wide range. These polymers can be in the form of particles that do not have a large ratio of greatest dimension to smallest dimension (e.g., granules, flakes, pulverulents, interparticle aggregates, interparticle crosslinked aggregates, and the like) or they can be in the form of fibers, sheets, films, foams, laminates, and the like. The use of superabsorbent gelling polymers in fibrous form provides the benefit of enhanced retention, relative to particles, during the cleaning process. While their capacity is generally lower for aqueous-based mixtures than it is for water, these materials still demonstrate significant absorbent capacity for such mixtures. The patent literature is replete with disclosures of water-swellable materials. See, for example, U.S. Pat. No. 3,699,103 (Harper et al.), issued Jun. 13, 1972; U.S. Pat. No. 3,770,731 (Harmon), issued Jun. 20, 1972; U.S. Reissue Pat. No. 32,649 (Brandt et al.), reissued Apr. 19, 1989; U.S. Pat. No. 4,834,735 (Alemany et al.), issued May 30, 1989.

Superabsorbent gelling polymers useful in the present invention include a variety of water-insoluble, but water-swellable polymers capable of absorbing large quantities of fluids. Such polymeric materials are also commonly referred to as “hydrocolloids”, and can include polysaccharides such as carboxymethyl starch, carboxymethyl cellulose, and hydroxypropyl cellulose; nonionic types such as polyvinyl alcohol, and polyvinyl ethers; cationic types such as polyvinyl pyridine, polyvinyl morpholinione, and N,N-dimethylaminoethyl or N,N-diethylaminopropyl acrylates and methacrylates, and the respective quaternary salts thereof. Typically, superabsorbent gelling polymers useful in the present invention have a multiplicity of anionic functional groups, such as sulfonic acid, and more typically carboxy, groups. Examples of polymers suitable for use herein include those which are prepared from polymerizable, unsaturated, acid-containing monomers. Thus, such monomers include the olefinically unsaturated acids and anhydrides that contain at least one carbon to carbon olefinic double bond. More specifically, these monomers can be selected from olefinically unsaturated carboxylic acids and acid anhydrides, olefinically unsaturated sulfonic acids, and mixtures thereof.

Where superabsorbent material is included in the absorbent layer of the cleaning pad, the absorbent layer will preferably comprise at least about 15%, by weight of the absorbent layer, more preferably at least about 20%, still more preferably at least about 25%, of the superabsorbent material.

The absorbent layer can also consist of, or comprise, fibrous material. Fibers useful in the present invention include those that are naturally occurring (modified or unmodified), as well as synthetically made fibers. Examples of suitable unmodified/modified naturally occurring fibers include cotton, Esparto grass, bagasse, kemp, flax, silk, wool, wood pulp, chemically modified wood pulp, jute, ethyl cellulose, and cellulose acetate. Suitable synthetic fibers can be made from polyvinyl chloride, polyvinyl fluoride, polytetrafluoroethylene, polyvinylidene chloride, polyacrylics such as ORLON®, polyvinyl acetate, Rayon®, polyethylvinyl acetate, non-soluble or soluble polyvinyl alcohol, polyolefins such as polyethylene (e.g., PULPEX®) and polypropylene, polyamides such as nylon, polyesters such as DACRON® or KODEL®, polyurethanes, polystyrenes, and the like. The absorbent layer can comprise solely naturally occurring fibers, solely synthetic fibers, or any compatible combination of naturally occurring and synthetic fibers.

The fibers useful herein can be hydrophilic, hydrophobic or can be a combination of both hydrophilic and hydrophobic fibers. As indicated above, the particular selection of hydrophilic or hydrophobic fibers will depend upon the other materials included in the absorbent (and to some degree the scrubbing) layer. That is, the nature of the fibers will be such that the cleaning pad exhibits the necessary fluid delay and overall fluid absorbency. Suitable hydrophilic fibers for use in the present invention include cellulosic fibers, modified cellulosic fibers, rayon, polyester fibers such as hydrophilic nylon (HYDROFIL®). Suitable hydrophilic fibers can also be obtained by hydrophilizing hydrophobic fibers, such as surfactant-treated or silica-treated thermoplastic fibers derived from, for example, polyolefins such as polyethylene or polypropylene, polyacrylics, polyamides, polystyrenes, polyurethanes and the like.

The absorbent layer of the cleaning pad can be comprised of a homogeneous material, such as a blend of cellulosic fibers (optionally thermally bonded) and swellable superabsorbent gelling polymer. Alternatively, the absorbent layer can be comprised of discrete layers of material, such as a layer of thermally bonded airlaid material and a discrete layer of a superabsorbent material. For example, a thermally bonded layer of cellulosic fibers can be located lower than (i.e., beneath) the superabsorbent material (i.e., between the superabsorbent material and the scrubbing layer). In order to achieve high absorptive capacity and retention of fluids under pressure, while at the same time providing initial delay in fluid uptake, it can be preferable to utilize such discrete layers when forming the absorbent layer. In this regard, the superabsorbent material can be located remote from the scrubbing layer by including a less absorbent layer as the lower-most aspect of the absorbent layer. For example, a layer of cellulosic fibers can be located lower (i.e., beneath) than the superabsorbent material (i.e., between the superabsorbent material and the scrubbing layer).

In a preferred embodiment, the absorbent layer will comprise a thermally bonded airlaid web of cellulose fibers (Flint River, available from Weyerhaeuser, Wash.) and AL Thermal C (thermoplastic available from Danaklon a/s, Varde, Denmark), and a swellable hydrogel-forming superabsorbent polymer. The superabsorbent polymer is preferably incorporated such that a discrete layer is located near the surface of the absorbent layer which is remote from the scrubbing layer. Preferably, a thin layer of, e.g., cellulose fibers (optionally thermally bonded) are positioned above the superabsorbent gelling polymer to enhance containment.

Other suitable absorbent layers for the cleaning pads are described in more detail in U.S. Pat. No. 6,048,123 to Holt et al., at col. 6, line 58 to col. 12, line 64, which is incorporated herein by reference.

B. Optional Liquid Pervious Scrubbing Layer

The cleaning pads to be demonstrated in the present methods optionally, but preferably, comprise a liquid pervious scrubbing layer. The scrubbing layer is the portion of the cleaning pad that contacts the soiled surface during cleaning. As such, materials useful as the scrubbing layer must be sufficiently durable that the layer will retain its integrity during the cleaning process. In addition, when the cleaning pad is used in combination with a solution, the scrubbing layer must be liquid pervious, at least in part, to be capable of transitioning liquids and soils to the absorbent layer. Whether the implement is used with a cleaning solution (i.e., in the wet state) or without cleaning solution (i.e., in the dry state), the scrubbing layer will, in addition to removing particulate matter, facilitate other functions, such as polishing, dusting, and buffing the surface being cleaned.

The scrubbing layer can be a monolayer, or a multi-layer structure one or more of whose layers can be slitted to facilitate the scrubbing of the soiled surface and the uptake of particulate matter. This scrubbing layer, as it passes over the soiled surface, interacts with the soil (and cleaning solution when used), loosening and emulsifying tough soils and permitting them to pass freely into the absorbent layer of the pad. The scrubbing layer preferably contains openings (e.g., slits, tapered capillaries or apertures) that provide an easy avenue for larger particulate matter to move freely in and become entrapped within the absorbent layer of the pad. Low density structures are preferred for use as the scrubbing layer, to further facilitate transport of particulate matter to the pad's absorbent layer.

In order to provide desired integrity, materials particularly suitable for the scrubbing layer include a wide range of materials such as woven and nonwoven materials; polymeric materials such as apertured formed thermoplastic films, apertured plastic films, and hydroformed thermoplastic films; porous foams; reticulated foams; reticulated thermoplastic films; and thermoplastic scrims. Suitable woven and nonwoven materials can comprise natural fibers (e.g., wood or cotton fibers), synthetic fibers such as polyolefins (e.g., polyethylene and polypropylene), polyesters, polyamides, and synthetic cellulosics (e.g., RAYON®), or from a combination of natural and synthetic fibers. Such synthetic fibers can be manufactured using known processes such as carded, spunbond, meltblown, airlaid, needle punched and the like. In a preferred aspect of the present invention, the cleaning pad comprises a liquid pervious scrubbing layer which comprises, at least in part, an apertured formed film. Apertured formed films are preferred for the liquid pervious scrubbing layer because they are pervious to aqueous cleaning liquids containing soils, including dissolved and undissolved particulate matter, yet are non-absorbent and have a reduced tendency to allow liquids to pass back through and rewet the surface being cleaned. Thus, the surface of the formed film which is in contact with the surface being cleaned remains dry, thereby reducing filming and streaking of the surface being cleaned and permitting the surface to be wiped substantially dry. Applicants have surprisingly found that an apertured formed film having tapered or funnel-shaped apertures, meaning that the diameter at the lower end of the aperture is greater than the diameter at the upper end of the aperature, actually exhibits a suctioning effect as the cleaning pad is moved across the surface being cleaned. This aids in moving liquid from the surface being cleaned to other layers of the cleaning pad, such as the absorbent layer(s). In addition, tapered or funnel-shaped apertures have an even greater tendency to prevent liquids from passing back through the scrubbing layer to the surface being cleaned once they have been transferred to other layers, such as the absorbent layer(s). Apertured formed films having tapered or funnel-shaped apertures are thus preferred. Suitable apertured formed films are described in U.S. Pat. No. 3,929,135, entitled “Absorptive Structures Having Tapered Capillaries”, which issued to Thompson on Dec. 30, 1975; U.S. Pat. No. 4,324,246 entitled “Disposable Absorbent Article Having A Stain Resistant Topsheet”, which issued to Mullane et al. on Apr. 13, 1982; U.S. Pat. No. 4,342,314 entitled “Resilient Plastic Web Exhibiting Fiber-Like Properties”, which issued to Radel et al. on Aug. 3, 1982; U.S. Pat. No. 4,463,045 entitled “Macroscopically Expanded Three-Dimensional Plastic Web Exhibiting Non-Glossy Visible Surface and Cloth-Like Tactile Impression”, which issued to Ahr et al. on Jul. 31, 1984; and U.S. Pat. No. 5,006,394 entitled “Multilayer Polymeric Film” issued to Baird on Apr. 9, 1991. Each of these patents are incorporated herein by reference. The preferred liquid pervious scrubbing layer for the present invention is the apertured formed film described in one or more of the above patents and marketed on sanitary napkins by The Procter & Gamble Company of Cincinnati, Ohio as DRI-WEAVE®.

C. Optional Cleaning Pad Components

The cleaning pad used in the present methods can also comprise a variety of other optional components/aspects such as an attachment layer, density gradient, functional cuffs, multiple widths in the z-dimension, and combinations thereof.

IV. Average Soil Suspension Test Method

The soil composition/dispersion to be tested is stirred on a stir plate for 3 to 5 minutes to ensure full mixture of the soil. The soil composition/dispersion is then poured into a 500 ml glass graduated cylinder (Pyrex® cylinder with a diameter of 2 inches (5.08 cm)) up to the 400 ml mark. A timer is started and at time intervals of 0, 1, 3, 5, 7, 9, and 10 minutes, the level at which the “sedimentation line” appears is recorded. The “sedimentation line” is the point at which there is a demarcation in the soil composition/dispersion such that the portion of the soil composition above that point is much less turbid and lighter in color that the portion of the soil composition below that point. At the given time intervals, the location of the sedimentation line is recorded in relation to the graduated milliliter markings on the side of the 500 ml glass graduated cylinder.

All of the documents and references referred to herein are incorporated by reference, unless otherwise specified. All parts, ratios, and percentages herein, in the Specification, Examples, and claims, are by weight and all numerical limits are used with the normal degree of accuracy afforded by the art, unless otherwise specified.

The following are non-limiting examples of the present invention.

### EXAMPLE I

The following examples are representative of the soil compositions of the present invention.

| Soil Components | Soil Example A | Soil Example B |
|---|---|---|
| Clay ^{a} | 67% | 71% |
| Cement ^{b} | 27% | 28.4% |
| Carbon Black ^{c} | 0.5% | 0.6% |
| Dispersant ^{d} | 5.5% | — |

^{a} Commercially available from Kentucky-Tennessee Clay Company (Mayfield, Kentucky USA) under the trade name Todd Dark Clay.
^{b} Commercially available from Quickcrete ® under the trade name Type I Portland Cement.
^{c} Commercially available from Mallinckrodt Baker, Inc. (Phillipsburg, NJ USA).
^{d} Polyethyleneimine dispersant.

Soil Example A is dispersed in water at a level of about 0.93%, by weight, to form Soil Example C. Soil Example B is dispersed in water at a level of about 0.93%, by weight, to form Soil Example D. Soil Examples C and D are soil dispersions that contain about 99.07% water, by weight.

### EXAMPLE II

This example represents the average soil suspension of Soil Examples C and D. Each soil dispersion is subjected to the Average Soil Suspension Test Method described in Section IV herein. The location of the sedimentation line is measured for each soil dispersion at 0, 1, 3, 5, 7, 9, and 10 minute intervals. The Average Soil Suspension Test Method is run twice for each soil dispersion and averaged. The results are recorded in the following table.

| | Average Soil Suspension | |
|---|---|---|
| | (location of Sedimentation Line | |
| | at ml mark in graduated cylinder) | |
| Time (minutes) | Soil Example C | Soil Example D |

| | | |
|---|---|---|
| 0 | 400 ml | 400 ml |
| 1 | 390 ml | 380 ml |
| 3 | 373 ml | 348 ml |
| 5 | 243 ml | 148 ml |
| 7 | 142 ml | 103 ml |
| 9 | 70 ml | 50 ml |
| 10 | 60 ml | 40 ml |

These results show that Soil Example C, which contains a dispersant, is a more turbid solution and the soil components settle out of solution less quickly as compared to Soil Example D, which does not contain a dispersant.

What is claimed is:

1. A method of demonstrating the cleaning performance of a cleaning pad, said method comprising the steps of:
(a) providing a soil composition comprising fine particulate matter, optional colorant, and optional dispersant; wherein said soil composition has a mean particle size of from about 1 μm to about 1,000 μm;
(b) distributing said soil composition on a demonstration surface; and
(c) wiping said demonstration surface with said cleaning pad.

2. The method of claim 1 wherein said soil composition is distributed across the demonstration surface at a level of less than about 6 ml of soil composition per square foot of demonstration surface.

3. The method of claim 1 wherein said method further comprises the step of spreading said soil composition across said surface with a utensil to more evenly cover said surface with said soil composition.

4. The method of claim 3 wherein said utensil is a spatula.

5. The method of claim 1 wherein said soil composition is dry and said method further comprises the step of combining said soil composition with an aqueous carrier to form a soil dispersion, wherein said soil dispersion is then distributed across said surface.

6. The method of claim 5 wherein said soil dispersion comprises from about 20% to about 99.9%, by weight of the soil dispersion, of aqueous carrier comprising water.

7. The method of claim 1 wherein said method further comprises the step of applying a hard surface cleaning solution to said surface after said soil composition is distributed to said surface and before said cleaning pad is wiped across said surface.

8. The method of claim 1 wherein said method further comprises the step of attaching said cleaning pad to a cleaning implement before said cleaning pad is wiped across said surface.

9. The method of claim 8 wherein said cleaning implement comprises a fluid dispenser and said method further comprises the step of applying a hard surface cleaning solution to said surface by spraying said cleaning solution through said fluid dispenser before wiping said cleaning pad across said surface.

10. A soil composition for demonstrating the performance of a cleaning pad, said composition comprising:
(a) fine particulate matter;
(b) optional colorant; and
(c) optional dispersant;
wherein said soil composition has a mean particle size of from about 1 μm to about 1,000 μm.

11. The soil composition of claim 10 wherein said composition further comprises a colorant selected from the group consisting of graphitic carbons, iron oxide, natural burnt umber, chromium oxide, ultra marine blue, titanium dioxide and any combination thereof.

12. The soil composition of claim 10 wherein said composition further comprises a dispersant selected from the group consisting of surfactants, ethoxylated polyalkylamines, propoxylated polyalkylamines, carboxylate polymers, nitrogen-based zwitterionic polymers, polyethyleneoxides, polyphosphates, cellulosic polymers, and any combination thereof

13. The soil composition of claim 10 wherein said composition exhibits a sedimentation line after 5 minutes at greater than about 150 ml, as measured according to the Average Soil Suspension Test Method.

14. The soil composition of claim 10 wherein said composition has a mean particle size of from about 10 μm to about 600 μm.

15. The soil composition of claim 14 wherein said composition is comprised of at least about 60% of particles having a particle size of less than about 200 μm.

16. The soil composition of claim 10 wherein said composition is free of naturally-occurring household soil material.
